(19) United States
(12) Patent Application Publication
(10) Pub. No.: US 2007/0276868 A1
(43) Pub. Date: Nov. 29, 2007

(54) Single point of access to land records

(76) Inventor: Peter Schlussler, Mount Sinai, NY (US)

Correspondence Address: LEE GROSSKREUZ HECHTEL;JASPAN SCHLESINGER HOFFMAN LLP, 300 GARDEN CITY PLAZA, GARDEN CITY, NY, 11530, US

(21) Appl. No.: 11/441,717

(22) Filed: May 26, 2006

(51) Int. Cl. G06F 17/00

(52) U.S. Cl. 707/104.1

(57) ABSTRACT

There is provided a system and method for performing a search for property records stored and maintained across a plurality of data stores, each data store storing and maintaining property records by a type of records, comprising: generating a virtual view of the data records maintained by the plurality of data stores; selecting a search type for the type of records to search; entering search criteria in accordance with the selected search type; executing at least one search of the virtual view using the entered search criteria and the selected search type; and retrieving resulting data and displaying one or more records of the resulting data by the type of records. The system and method further provide the ability to save the performed search, automatically re-execute the saved search at preset set periodicity, and notify a subscriber of any changes in resulting data as applicable.

### BACKGROUND OF THE INVENTION

1. Technical Field of the Invention

The present invention relates generally to accessing data and recorded documents relating to land and land transaction (property records). More particularly, the present invention is directed to a system and method for delivering to the consuming public dynamic search and retrieval mechanisms of property records in a single-point-of-access, efficient and real-time manner.

2. Description of the Prior Art

In general, records related to parcels of land (i.e., “property”) are recorded in a County Clerk's Office (“County Clerk”) for the county in which the property is situated. More specifically, the county clerk is responsible to recording mortgages, deeds, acquisitions and transfers, judgments, liens (including federal, mechanics and miscellaneous liens), Uniform Commercial Codes (“UCCs”), Court actions, filed maps, tax maps, abandonments, abstracts and other related property information (all documents hereinafter referred to as “property records”), all in connection with the property located in that county. The aforementioned property records are recorded to enable title searches for both residential and commercial property, background searches for employment and credit worthiness, generation of property lists by list makers, and general access to any records necessary to provide the appropriate checks and balances to lay claim to property, as well as, providing property records to a variety of businesses that use such property records as an integral part of their business models.

The recording and search of property records have traditionally been manual, time-intensive processes. The County Clerk receives thousands of property records daily. These property records are recorded and indexed in disparate data stores or silos of records in accordance with the type of property records. For example, all mortgages are recorded and indexed with other mortgages. The manual recording of property records and manual searches of (or access to) the property records has represented a significant investment of time, effort and money, both to the County Clerk and to the consuming public. An industry of title searchers had been borne by the necessity of expedient searches of the disparate data stores.

In today's marketplace there is demand for access to property records as a real-time commodity and for the ability to perform data mining on a real-time basis. Not until fairly recently has the County Clerk undertaken the voluminous process of digitizing the records in the disparate data stores to provide electronic access to the data stores, facilitating speedier searches and retrieval of the property records. The electronic search and retrieval mechanisms are generally limited to the County Clerk's Office and afford very rudimentary capability of searching each individual data store independently. Retrieving property records from the disparate data stores invariably requires the user (i.e., searcher) to create different searches using a variety of formats for the disparate data stores. A drawback to or a limiting factor of this type of searching is that it is time consuming and not accurate for ensuring that the desired property records are actually retrieved. For example, if the searcher wanted to retrieve property records associated to a particular property, the searcher would have to search each of the aforementioned disparate data stores (e.g., mortgages, deeds, judgments, etc.) with no clear and obvious relationship to the searcher between the records of any one data store with respect to any other data store. In addition, the searcher would encounter a different formatting for searching each of the disparate data stores for the particular property.

Notwithstanding the rudimentary search capability and the formatting issues identified above, in the real-estate field the searcher would further encounter significant data latency issues with respect to the particular searches and would have to perform several additional searches to obtain up-to-date property records for a particular property to reduce the latency inherent the searches. For example, for a title “closing” of particular property, the searcher would perform an original search to determine any mortgages, liens or judgments, etcetera, for the property and then would need to perform an additional search as close to the time and date of the title closing as possible in order to ascertain that no additional mortgages, liens or judgments, etc. have been entered against the property between the original search and later search.

As the property records represent a real-time commodity and real-time data mining therefore being a crucial factor, there is a need in the art to provide a system and method for delivering to the consuming public search and retrieval mechanisms of the property records in a single-point-of-access, efficient and real-time manner.

### SUMMARY OF THE INVENTION

The present invention is directed to a system and methods for providing a single point of access for land records.

According to an embodiment of the present invention, there is provided a method for performing a search for property records stored and maintained across a plurality of data stores, each data store storing and maintaining property records by a type of records, the method comprising: generating a virtual view of the data records maintained by the plurality of data stores; selecting a search type for the type of records to search; inputting search criteria in accordance with the selected search type; executing at least one search of the virtual view using the inputted search criteria and the selected search type; and retrieving resulting data and displaying one or more records of the resulting data by the type of records.

According to another embodiment of the present invention, there is provided an online electronic system for performing a search of property records over a network, the system comprising: at least one computing device for generating one or more search requests to perform the search of property records over the network; a plurality of land data stores, each data store storing and maintaining property records for a type of records; and a virtual land kiosk for: generating a virtual view of the data records maintained by the plurality of data stores; receiving from the computing device a search type for the type of records to search and search criteria in accordance with the search type for each search request; executing at least one search of the virtual view using the inputted search criteria and the selected search type for each search request; and transmitting resulting data including one or more records by the type of records to the at least one computing device for display.

According to yet another embodiment of the present invention, there is provided a program storage device readable by a machine, tangibly embodying a program of instructions executable on the machine to perform a method for performing a search for property records stored and maintained across a plurality of data stores, each data store storing and maintaining property records by a type of records, the method comprising the steps of: generating a virtual view of the data records maintained by the plurality of data stores; selecting a search type for the type of records to search; inputting search criteria in accordance with the selected search type; executing at least one search of the virtual view using the inputted search criteria and the selected search type; and retrieving resulting data and displaying one or more records of the resulting data by the type of records.

### BRIEF DESCRIPTION OF THE DRAWINGS

The features and advantages of the present invention will become apparent to one skilled in the art, in view of the following detailed description in combination with the attached drawings, in which:

FIG. 1 is an exemplary online system providing single point of access to land records in accordance with the present invention;

FIG. 2 is an exemplary top level method flowchart for the online single point of access to land records system of FIG. 1;

FIG. 3 is an exemplary method flowchart for performing a search using the online single point of access to land records system of FIG. 1;

FIG. 4 is an exemplary method flowchart for generating a watch for a particularly executed search using the online single point of access to land records system of FIG. 1;

FIG. 5 is an exemplary method flowchart for generating an abstract of a resulting data for a particularly executed search using the online single point of access to land records system of FIG. 1;

FIG. 6 is an exemplary method flowchart for exporting a particularly executed search in accordance with the present invention using the online single point of access to land records system of FIG. 1;

FIG. 7 is an exemplary homepage for the online single point of access to land records system of FIG. 1;

FIG. 8 is an exemplary web page transmitted to a subscriber upon logging into the online single point of access to land records system of FIG. 1;

FIG. 9 is an exemplary web page transmitted to a subscriber depicting a list of watches that includes one or more records pertaining to executed searches using the online single point of access to land records system of FIG. 1;

FIG. 10 is an exemplary web page transmitted to the subscriber depicting resulting data obtained as result of search performed by search type using online single point of access to land records system of FIG. 1;

FIG. 11 is an exemplary listing of possible search types displayed for subscriber's selection upon the subscriber selecting to perform a search in the exemplary web page transmitted to a subscriber in FIG. 8 using the online single point of access to land records system of FIG. 1; and

FIG. 12-19 are exemplary web pages transmitted to the subscriber for collecting input search criteria to perform different searches in accordance with the different possible search types selected by the subscriber in accordance with FIG. 11 using the online single point of access to land records system of FIG. 1.

### DETAILED DESCRIPTION OF THE PREFERRED EMBODIMENTS OF THE INVENTION

The present invention is directed to a system and methods for delivering to the consuming public dynamic search and retrieval mechanisms of property records in a single-point-of-access, efficient and real-time manner.

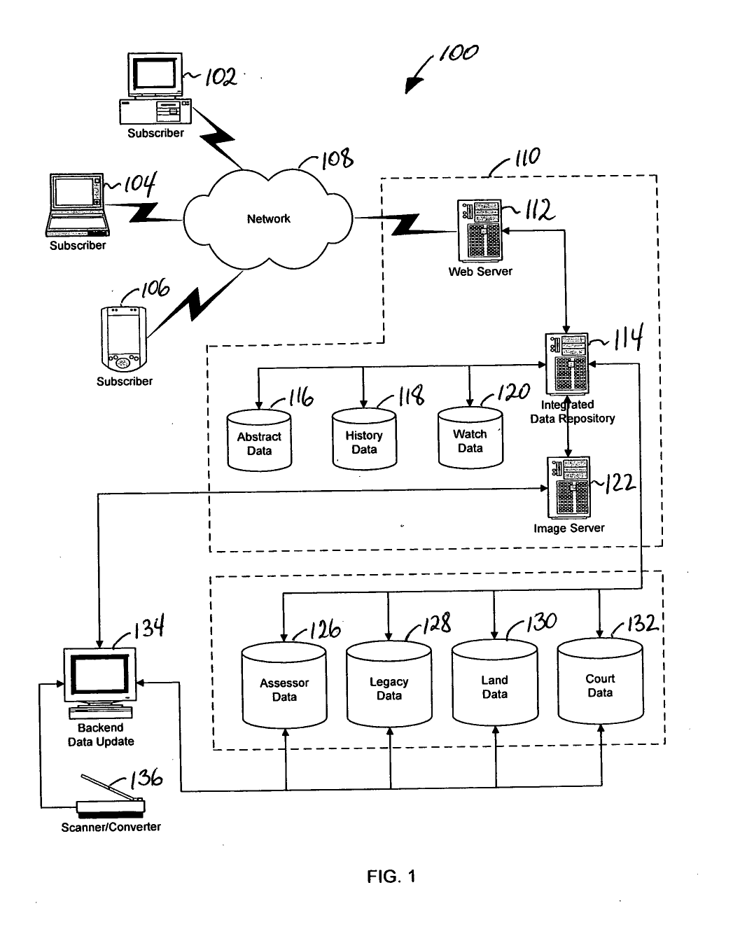

FIG. 1 depicts an exemplary single point of access to land records system 100 in accordance with the present invention. The land records system 100 comprises one or more subscribers (or clients) 102-106, a network 108, a virtual land kiosk 110, land records data 124, and one or more of backend data update 134 and scanner/converter 136. The land records system 100 as viewed from one or more subscribers 102-06 is of a client/server architecture, while the virtual land kiosk 110, land records data 124, and one or more of backend data update 134 and scanner/converter 136 can be viewed as elements of a data warehousing architecture. The one or more subscribers 102-106 may include one or more desktop clients 102, one or more laptop clients 104, or one or more hand held clients 106 (e.g., PDA, palm devices, etc.), which are adapted to connect to and communicate over network 108 via wireless or wired connections known in the art. It will be appreciated that any computing device capable of connecting to and being able of communicating over network 108 is considered with the scope of the present invention.

Further with reference to FIG. 1, the network 108 may be the Internet, an intranet, or any other network capable of interconnecting the one or more subscribers 102-106 and the virtual land kiosk 110, and the network 108 preferably supports TCI/IP (transfer control protocol/internet protocol), or otherwise any other protocol for such interconnection/communication. The virtual land kiosk 110 represents an amalgam of servers and databases across an enterprise, which as a unit provides any subscriber (client) 102-106 a single point of access to land records data and associated functionality represented by the virtual land kiosk 110, as will be elucidated in more detail below. Each of the one or more subscribers (clients) 102-106, being equipped with a web browser and using a predefined IP address (or domain name) for the virtual land kiosk 110 may access the land records data and associated functionality provided by the virtual land kiosk 110.

Still further with reference to FIG. 1, the virtual land kiosk 110 comprises the web server 112, the integrated data repository 114, the abstract data store 116, the history data store 118, the watch data store 120, as well as the image server 122, all of which will be elucidated in greater detail herein below. It is to be noted that each of the web server 112, the integrated data repository 114 and the image server 122 is depicted as one physical machine for clarity and brevity of the description, and that each of the aforementioned components can be one or more logical or physical machines as required by the implementation of the land records system 100. Internet Information Services (i.e., IIS) is resident on the web server 112, and the IIS acts as a broker for passing packetized information (e.g. requests, responses, data, etc.) between the subscribers 102-106 and the integrated data repository 114. The integrated data repository 114 stores a virtual combined view of the data records maintained by the individual data stores 126-132 of land records data 124, to which the integrated data repository 114 is interconnected, as particularly depicted in FIG. 1. More specifically, the data records maintained by the data stores 126-132 are replicated in a predetermined periodicity to the integrated data repository 114 using “materialized views”. A materialized view allows a user to query very large amount of data in seconds, which is accomplished by transparently using pre-computed summarizations of data. These pre-computed summaries would typically be very small compared to the original source data.

The data stores 126-132 of FIG. 1 store a variety of information associated with the property records. As the information related to the property records is stored and maintained across disparate data stores 126-132, the information is related by relational keys, e.g., primary, foreign and surrogate keys. However, the relationships between the information can be primarily characterized or related in most cases, as a starting point, by Tax Map ID and/or a name associated to the property record. The Tax Map ID is a unique identification assigned to the property by the County in which the property is situated. The name can be that of a claimant, grantor/grantee, mortgagor/mortgagee, litigant (plaintiff or defendant), attorney name, and the like. The components of the virtual land kiosk 110 and land records data 124 may be interconnected via a local area network, a wide area network, the Internet, and the like. The integrated data repository 114 is interconnected further to the image server 122, which stores images of specific recorded documents associated with the data records maintained by the individual data stores 126-132 of land records data 124 and further associated with the data records of virtual combined view maintained by the integrated data repository 114. It is to be noted that the different components of the system 100 may be logically or physically associated with other components without departing from the teachings of the present invention.

Yet further with reference to FIG. 1, communication between the virtual land kiosk 110 and the one or more subscribers is primarily handled by the web server 112. It will be appreciated that the web server 112 may be one or more physical or logical machines, which provide interconnection/communication between subscribers 102-106 and the virtual land kiosk 110. However, to impart clarity, the web server 108 is depicted as one machine. The web server 112 provides the core functionality for enabling the single point of access to the land records data 122 in accordance with the present invention. That is, the web server 112 provides the core functionality to interconnect the one or more subscribers 102-106 to the land records data 122, to authenticate the one or more subscribers 102-106 via username and password, to authorize the one or more subscribers 102-106 for certain associated services, and to deliver authorized web pages and other content to the one or more subscribers 102-106, and the like, as will be elucidated herein below in more detail.

Still yet further with reference to FIG. 1, the integrated data repository 114 is interconnected to and controls the data records in the abstract data store 116, the history data store 118 and the watch data store 120. The abstract data store 116 maintains a virtual copy of data abstracted by a subscriber 102-106 (i.e., abstracted data), as will be elucidated below in more detail. The virtual land kiosk 110 may allow the subscriber 102-106 to save the abstracted data within the abstract data 116 of the virtual land kiosk 110 or to transmit the abstracted data to the subscriber 102-106 for printing and/or saving at the subscriber's device (e.g., PC, PDA, etc.). The history data store 118 maintains data associated with searches performed by subscribers on particular parcels of land (i.e., history data), as will be elucidated in more detail below. The watch data store 120 maintains data associated with each particular subscriber's searches performed using the land records system 100 (i.e., watch data), as will be elucidated herein below.

Finally with reference to FIG. 1, and as noted above, the land records system 100 may comprise one or more of the backend data update 134 and scanner/converter 136, for scanning or converting recorded documents associated with land transactions into digital images, such as PDF. Although scanner/converter 136 is depicted as one physical device for clarity and brevity, it is to be understood that a number of different devices may be used for the respective functionality. That is, an optical scanner may be used to optically scan paper-based documents into digital images, such as PDF images. Additionally, microfilm and liber book converters may be used to convert microfilm images or liber book pages to digital images, such as PDF images. It is to be noted that any number of other devices not specifically enumerated may be used to scan or convert a variety of recorded documents, whether or not specifically enumerated, into digital images for use in the land records system 100. The backend data update 134 is interconnected to the image server 122 and the data stores 126-132 of land records data 124. The personnel of the County Clerk's office periodically scan the recorded documents for particular land transactions and associate these documents with the particular records stored in the data stores 126-132 of the land records data 124, as well as with the particular records in the integrated data repository 114. More specifically, as described hereinabove paper documents are optically scanned and documents recorded on microfilm or in libers are converted, using appropriate devices for each document type, into a digitized format, such as PDF. The digital images are then stored in the image server 122 and indexed, with the indices being stored to either land data 130 or court data 132, as legacy data 128 is static and assessor data 126 is data that relates to records of data stores 128-132. The indices are replicated from the foregoing data stores 130 and 132 to the integrated data repository 114 in the replication process described with reference to data stores 126-132 hereinabove.

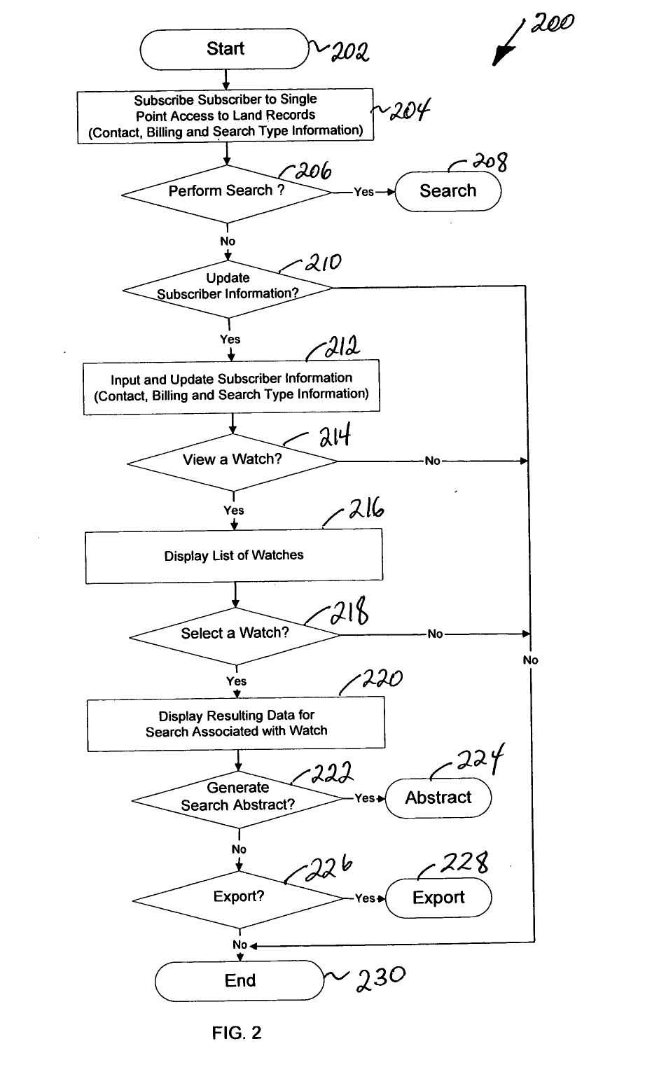

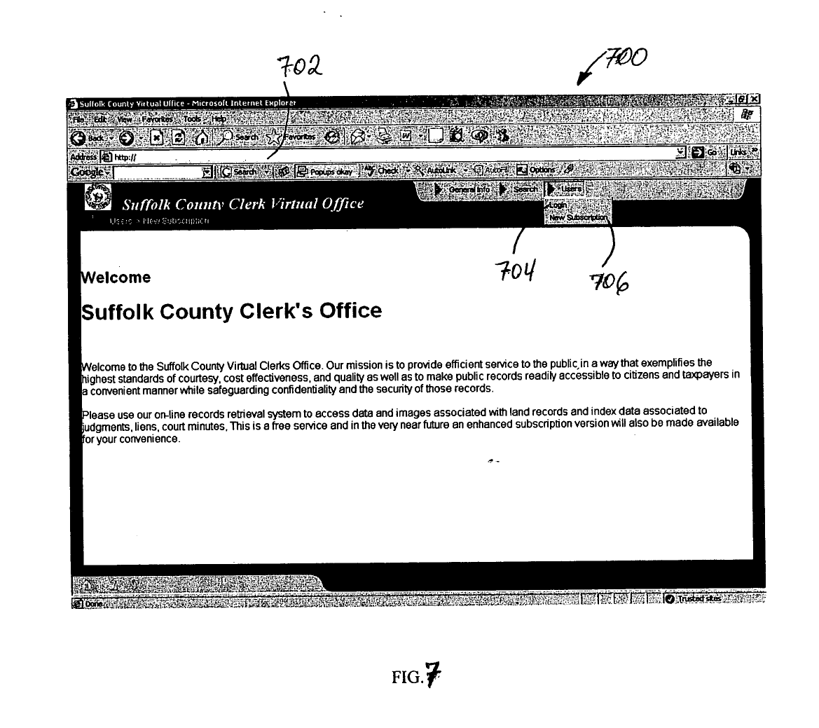

FIG. 2 depicts an exemplary top level method flowchart 200 for the single point of access to land records system 100, in accordance with the present invention. The method 200 starts at step 202. Next, at step 204, a user (subscriber) 102-106 subscribes to the single point of access to land records system 100. More particularly, a user 102-106 that would like to use the single point of access to land records system 100 enters the particular address for homepage of the land records system 100 in the user's internet browser. The web server 112 transmits to the user 102-106 via the network 108 a homepage to login or subscribe to the single point of access to land records system 100. FIG. 7 depicts an exemplary homepage 700 for logging into or subscribing to the single point of access to land records system 100. More particularly with reference to FIG. 7, the user 102-106 enters the address for the land records system 100 into the address field 702 of their web browser, and a request is formed and transmitted from the user's web browser to the web server 112, which returns the homepage 700 to the user 102-106. The user is then able to either login into or to subscribe to the land records system 100, by clicking on the respective login 704 or new subscription 706 links on the homepage 700. The subscription entails the collection of required information, including contact information, billing information (including credit card charge authorization) and subscription information (specific search-associated information). The creation, storage and management of the subscription, including the collected information, are performed by the integrated data repository 114.

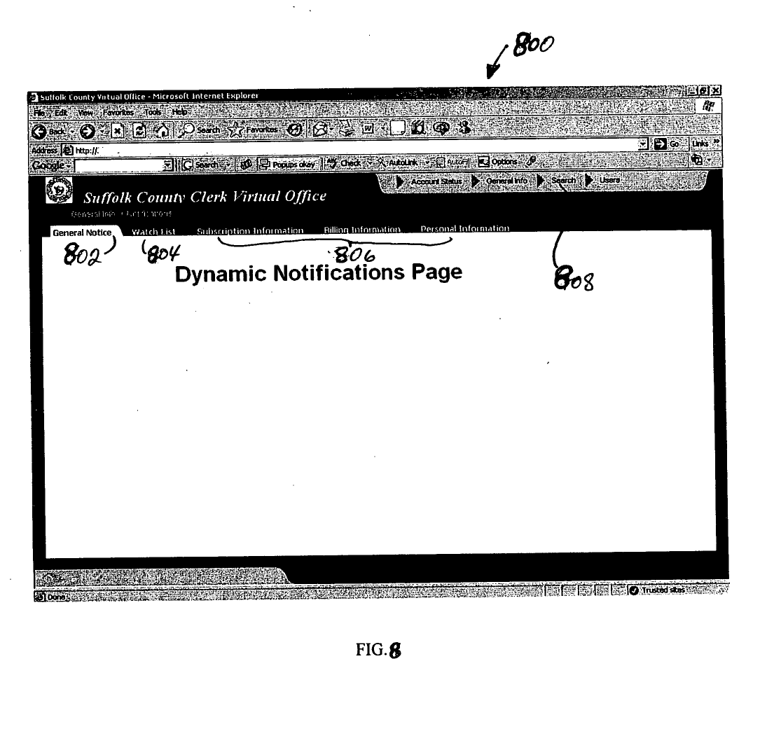

Now further with reference to FIG. 2, upon a user's new subscription, the integrated data repository 114 creates and manages a user account for the newly subscribed user 102-106 via appropriate tables that store user information associated with the user account. Once subscribed, the user is able to login into the land records system 100 via a username and password, which are selected by the user (not shown). FIG. 8 depicts an exemplary web page 800 transmitted to the subscriber upon logging into the land records system 100. More specifically, the general notice tab 802 is displayed to the subscriber upon login, which notifies the subscriber of particular dates for notifications. That is, information is displayed to the user with regard to the state of the single point of access to land records system 100, other pertinent bulletins and the date range of data available in the system 100 for each particular type of records described hereinabove. As will be described and elucidated in particular detail with reference to FIGS. 2 and 8 below, the subscriber 102-106 may then select by clicking a respective tab, to view and/or update the watch list 804, the subscriber information 806 and may also select by clicking on the link 808 perform a search of land records maintained by the County Clerk's Office.

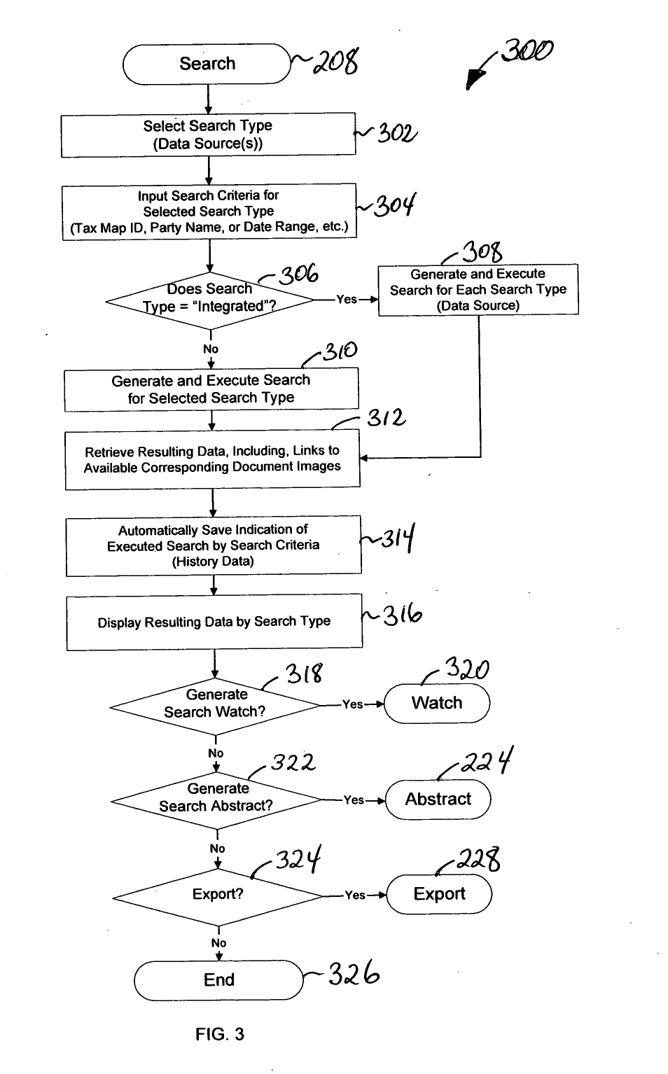

Further with reference to FIGS. 2 and 8, once logged into land records system 100, at step 206, it is determined whether the subscriber 102-106 desires to access land records by performing a search of the land records maintained by the County Clerk's Office. If the subscriber 102-106 desires to perform a search, the method continues with respect to the method flowchart described in FIG. 3, which begins at step 208. Alternatively, if the subscriber does not wish to perform a search, the method continues at step 210, where it is determined whether the subscriber would like to update subscriber information 806. If the subscriber chooses to update subscriber information, the method flowchart continues at step 212. Although the input web pages are not shown herein for simplicity and clarity, it will be appreciated that one or more web pages are transmitted from the web server 112 to the subscriber's web browser to collect and update information at the integrated data repository 114 regarding the subscriber's subscription, billing and personal information as it relates to the land records system 100.

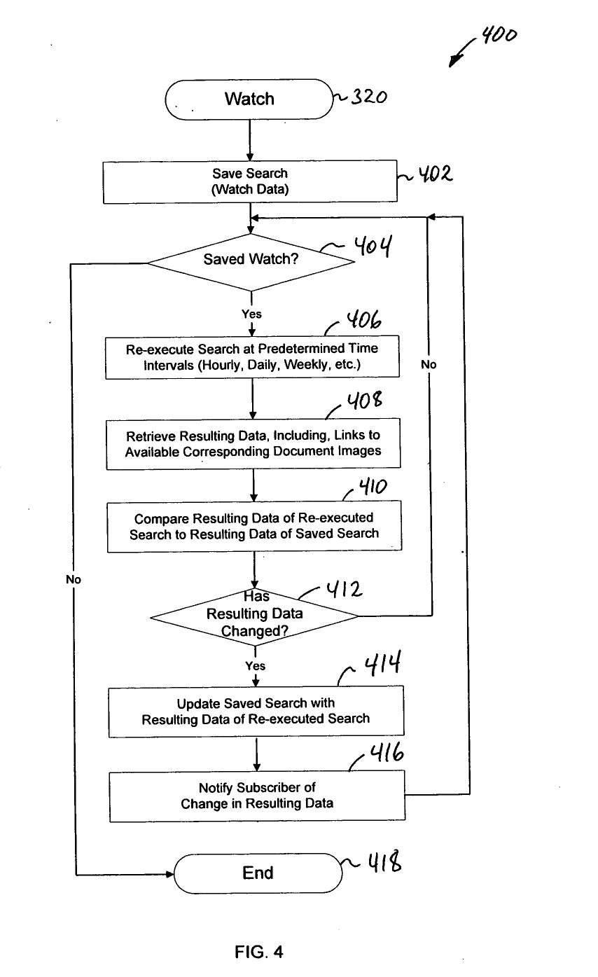

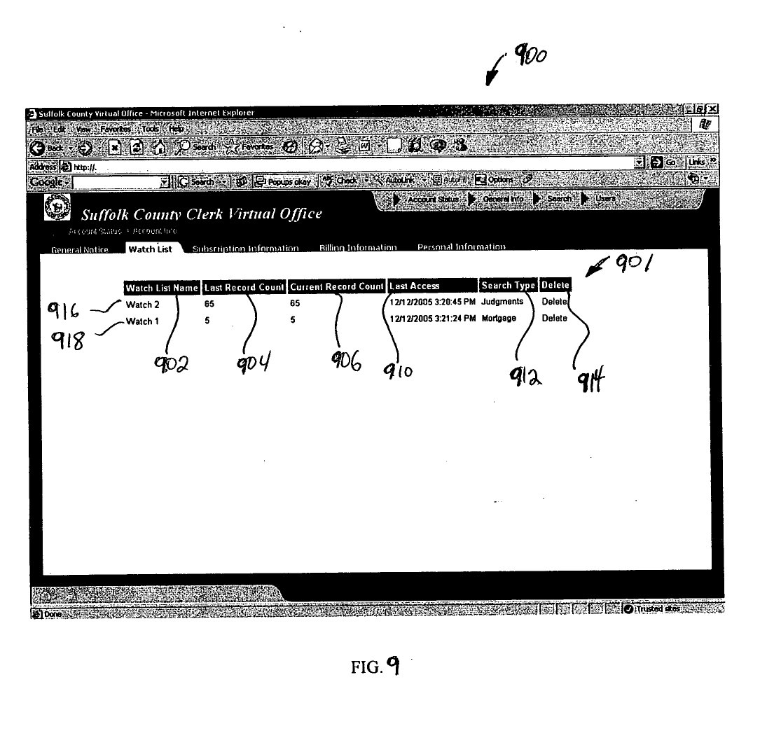

Yet further with reference to FIG. 2, at step 214, it is determined whether the subscriber 102-106 would like to view a list of one or more watches (i.e., for previously executed/saved searches) of the land records system 100, which are pre-generated and saved by the subscriber 102-106. The method for generating a watch will be described and elucidated in greater detail below with reference to FIG. 4. If the subscriber chooses not to view the list of watches at step 214, the method flowchart 200 continues at step 230, at which point the method flowchart 200 ends. Alternatively, the method flowchart continues at step 216, where the list of one or more watches generated previously by the subscriber is displayed to the subscriber 102-106, as particularly depicted FIG. 9. FIG. 9 depicts an exemplary web page 900 showing a list of watches 901, including one or more records (i.e., for previously executed/saved searches). In the exemplary list 901, two records (watches) 916, 918 are depicted for brevity and clarity. Each of the watches comprises the information pertinent to the particular search with which it is associated. More specifically, included in each record of the watch list 901 are the watch name, last record count 904 when search was previously run, current record count 906 for current run of search, last access date/time 910, search type 912, and a link 914 as to whether to delete the watch. The particular details of the information provided in the watches and its particular meaning within the land records system 100 will be described in more detail with reference to FIG. 3 below. As will be elucidated in greater detail with reference to FIG. 4, the records of the watch list 901 for each user are re-executed at predetermined time intervals (periodicity) using SQL batch jobs. The current record count 906 and last access date/time 910 are updated upon re-execution.

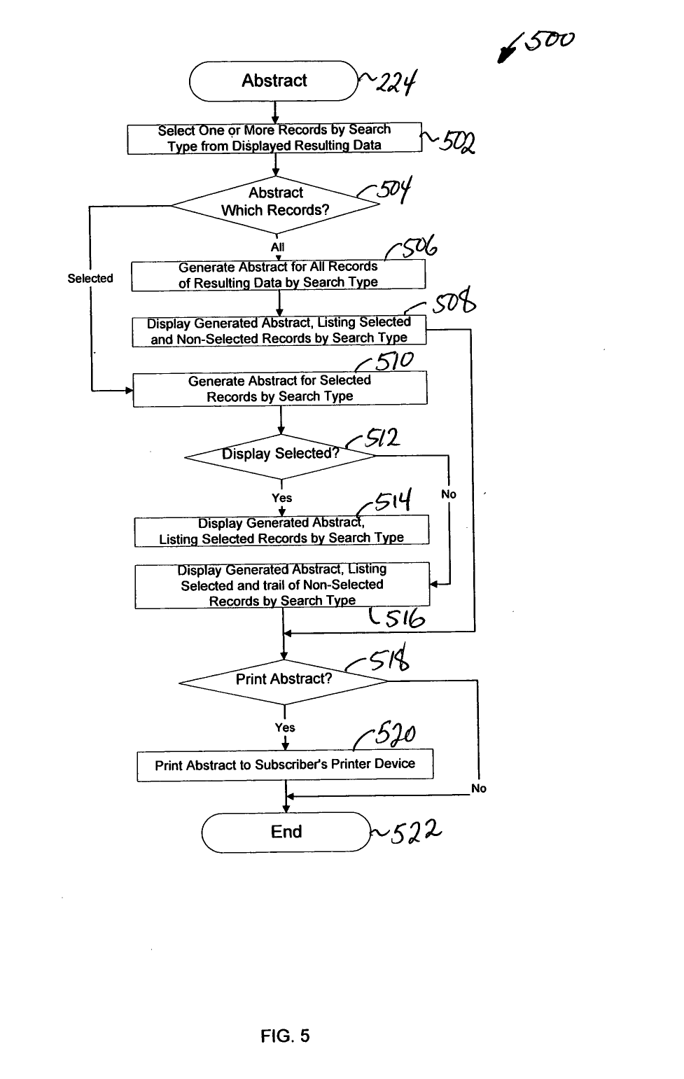

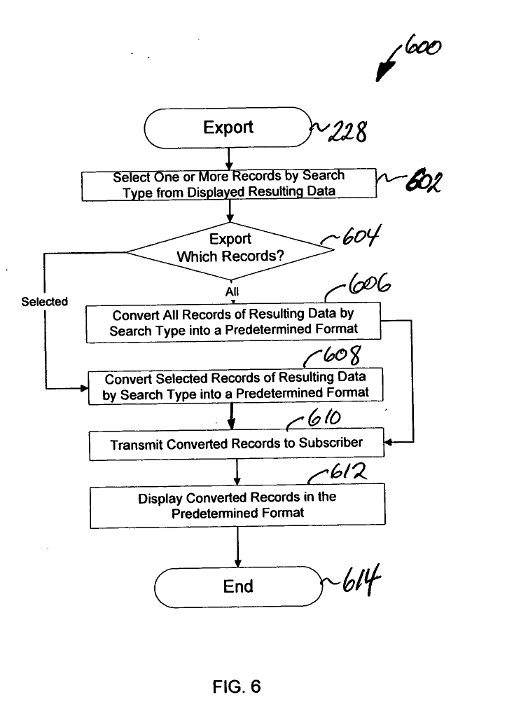

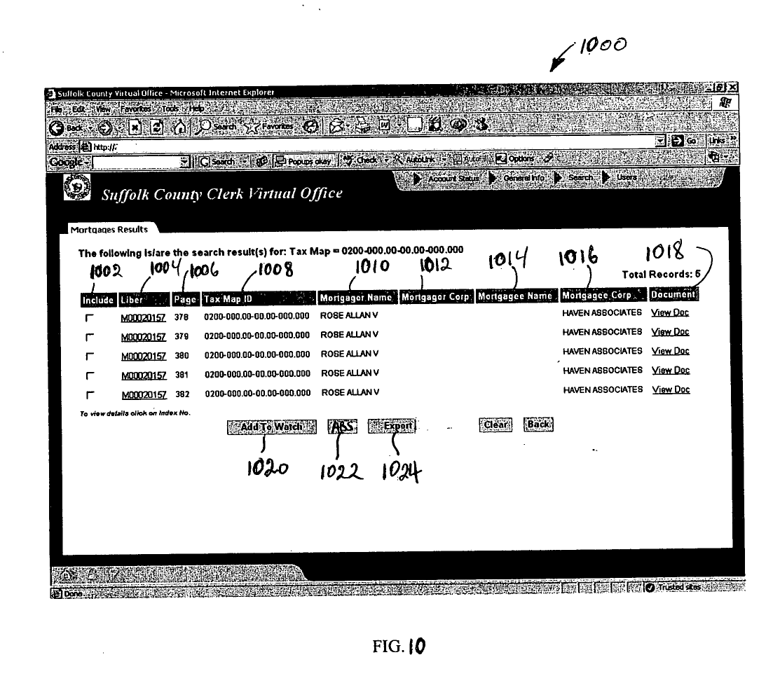

Still further with reference to FIG. 2, at step 218, it is determined whether the user has selected a watch listed in the list of watches displayed at step 216, as displayed in the exemplary list 901 of FIG. 9. If the subscriber chooses not to select a watch, the method flowchart 200 continues at step 230, at which point the method flowchart 200 ends. Alternatively, if the subscriber selects a watch by clicking on its name 902 in FIG. 9, the method flowchart 200 continues at step 220 in which resulting data is displayed for a search that is associated with the particular watch selected by the subscriber 102-106. For example, if the subscriber 102-106 selected “watch 1” 918 depicted in the exemplary web page 900 of FIG. 9, the web server 112 would retrieve from the integrated data repository 114 and transmit to subscriber 102-106 for display the records of the resulting data for that search, as particularly depicted in the exemplary web page 1000 of FIG. 10. As can be appreciated, the search for “watch 1” was for mortgage information 912 depicted in FIG. 9. The information included in each retrieved mortgage record is as follows: include/exclude from abstract checkbox 1002, liber link 1004, page within the liber 1006, tax map ID 1008, mortgagor name 1010, mortgagor corp. 1012, mortgagee name 1014, mortgagee corp. 1016 and a document link 1018 to the recorded document at the County Clerk Office. It is to be noted that the particular information displayed depends particularly on which search a subscriber has performed, e.g., mortgages, liens, lis pendens, etc. The method flowchart of FIG. 2 continues at step 222, where it is determined whether the subscriber 102-106 desires to generate an abstract of the retrieved search for display and/or printing. If the user desires to generate and abstract, the method continues at step 224 in FIG. 5. If the user does not choose to generate an abstract, the method flowchart 200 continues at step 226 where it is further determined whether the subscriber 102-106 desires to export the retrieved search. If export is desired, the method flowchart 200 continues at step 228 in FIG. 6. Alternatively, the method flowchart 200 continues at step 230 where it ends.

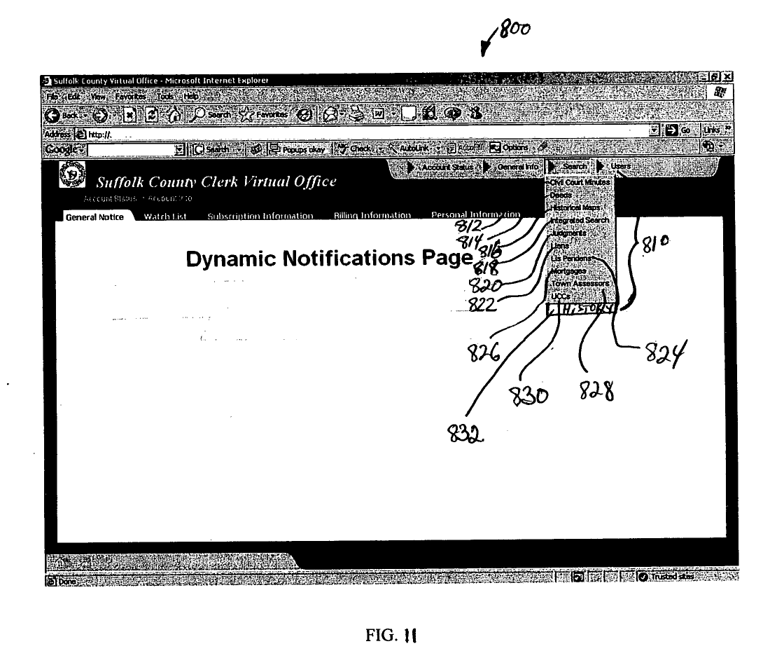

FIG. 3 depicts an exemplary method flowchart 300 accessing the land records system 100 by performing a search using the land records system 100, in accordance with the present invention. This method flowchart 300 continues at step 208 from FIG. 2. The search facility may be selected by the subscriber 102-106 by clicking on the search link 808 depicted and describer with reference to FIG. 8 above. Upon clicking link 808, a list of possible search types 810 is displayed to the subscriber for subscriber's selection, as particularly depicted in FIG. 11. The list of possible search types includes: civil court minutes 812, deeds 814, historical maps 816, integrated search 818, judgments 820, liens 822, lis pendens 824, mortgages 826, town assessors 828, UCCs (Uniform Commercial Codes) 830 and search history 832. Further with reference to FIG. 3, at step 302, the subscriber 102-106, selects a search type from the list 810. The subscriber's selection is transmitted from the subscriber 102-106 to the web server 112, which in turn transmits to the subscriber 102-106 an input web page that is associated with the selected search type and therefore includes input search criteria to be filled in by the subscriber to perform a search of the selected search type. It is important to note that the search type selected may be related to searching information of a particular data store 126-132 or information from the combined data stores 126-132. More specifically, the integrated search type 818 is related to a search type conducted for information stored across data stores 126-132.

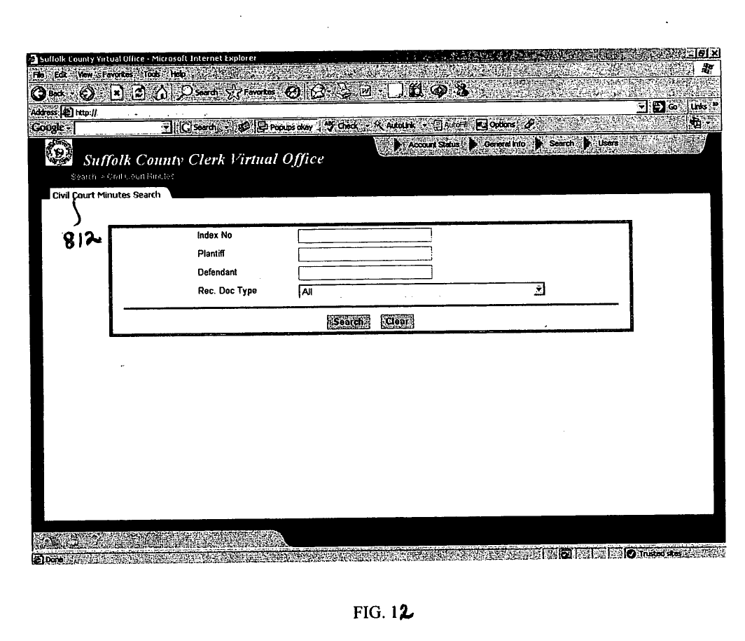

Now further with reference to FIG. 3, at step 304, the subscriber inputs some or all of the input search criteria for the selected search type and initiates a search. Based on the selected search type listed in 810, the search criteria may include similar, as well as, different search parameters based upon which the search of land records system 100 will be conducted. Additionally, the subscriber 102-106 may enter all or partial search criteria available to the subscriber for selected search type. Exemplary search criteria web pages for the different search types are depicted in FIGS. 12-19. The requested search, including the search criteria, is transmitted from the subscriber 102-106 to the web server 112.

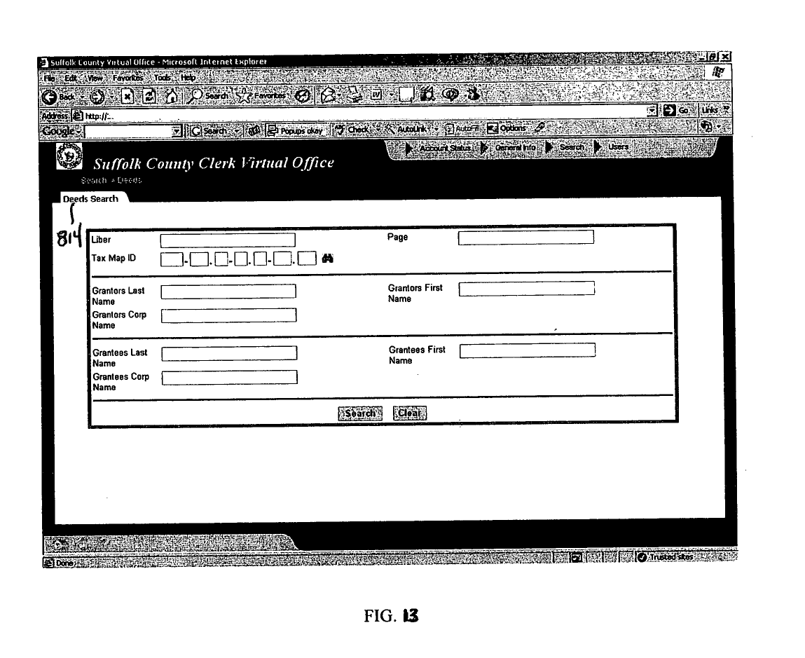

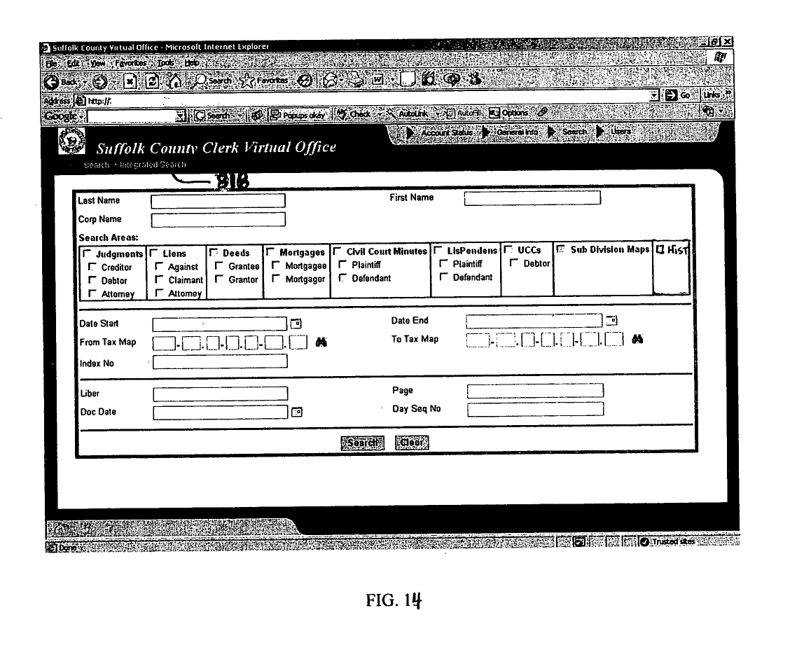

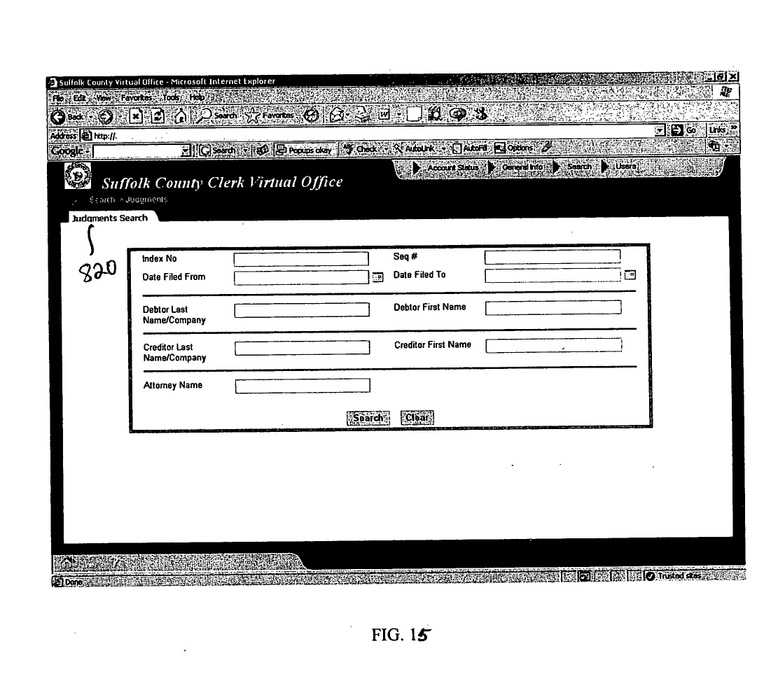

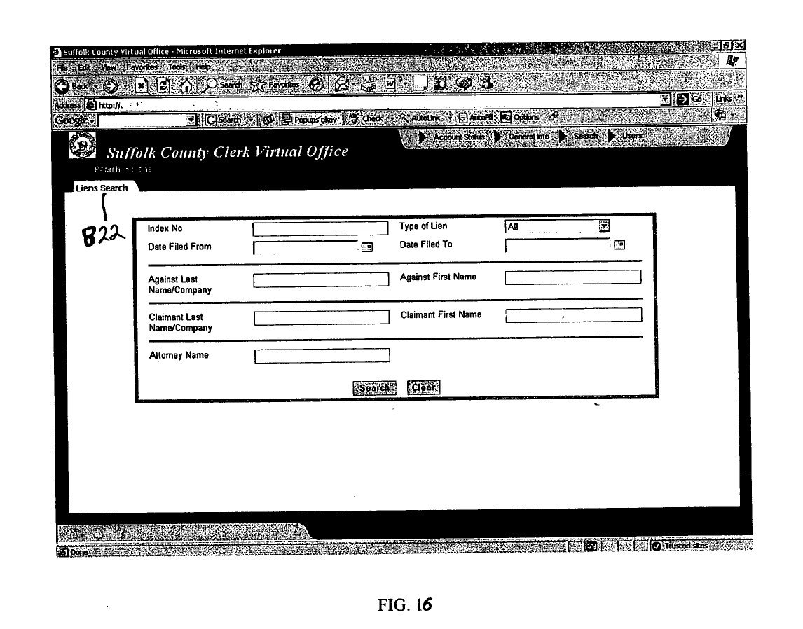

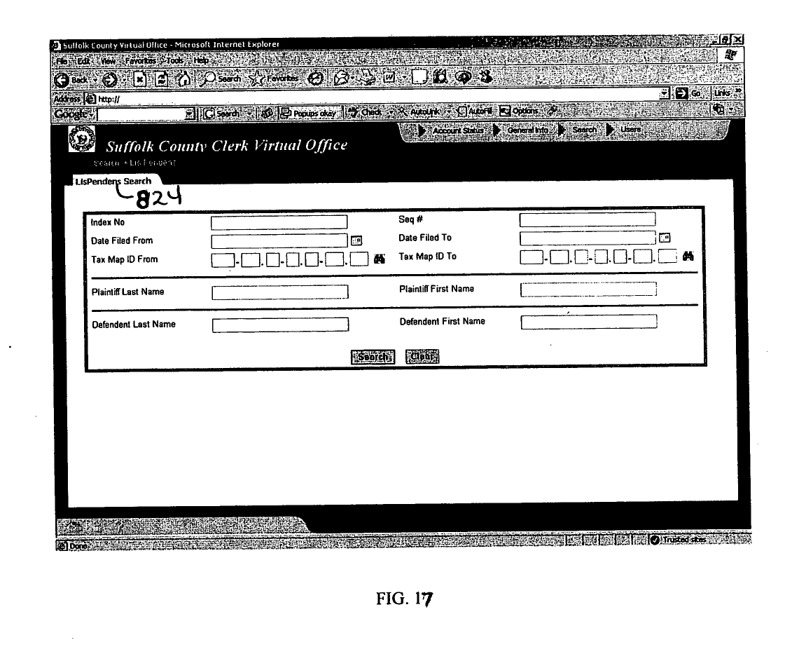

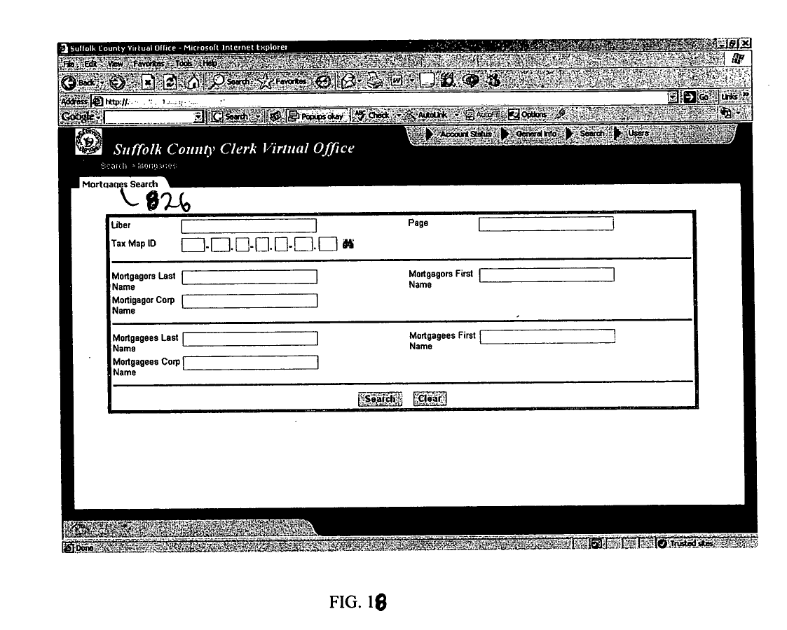

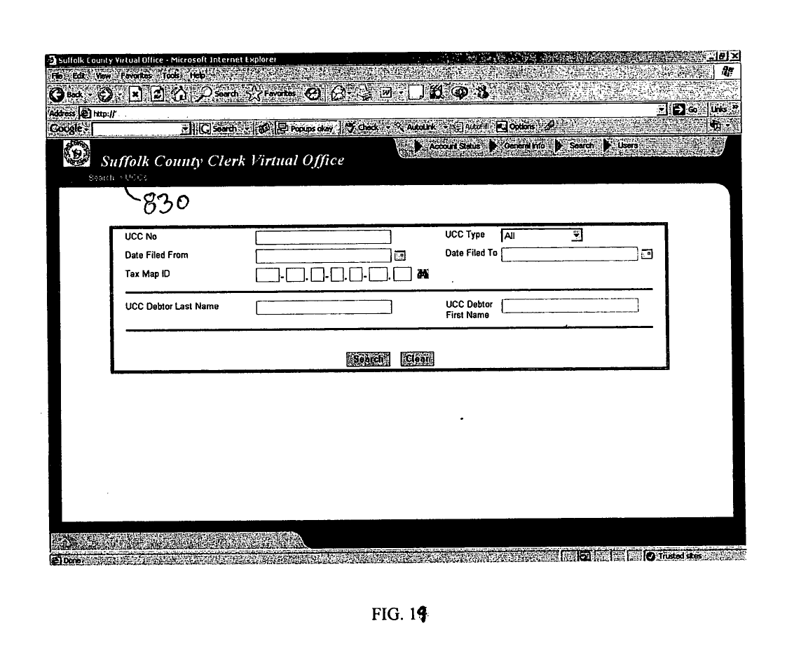

Now with reference to exemplary FIGS. 12-19, the input search criteria for civil court minutes 812 of FIG. 11 is depicted in the exemplary FIG. 12; deeds 814 in FIG. 13; historical maps 816 (not shown); integrated search 818 in FIG. 14; judgments 820 in FIG. 15; liens 822 in FIG. 16; lis pendens 824 in FIG. 17; mortgages 826 in FIG. 18; town assessors 828 (not shown); and UCCs 830 in FIG. 19. More specifically, civil court minutes 812 depicted in FIG. 12 includes the following input search criteria: index number, plaintiff, defendant, and record document type (e.g., affidavit, judgment, order, stipulation, etc.). The deeds 814 depicted in FIG. 13 includes the following input search criteria: liber and page, tax map ID, grantor's last name, grantor's first name, grantor's corporate name, grantee's last name, grantee's first name, and grantee's corporate name. The integrated search 818 depicted in FIG. 14 includes the following input search criteria: last name, first name, corporate name, selection of one or more search types, date range, tax map ID range, index number, liber and page, document date and day sequence number. The judgments 820 depicted in FIG. 15 includes the following input search criteria: index number, sequence number, date filed range; debtor last name/company, debtor first name, creditor last name/company, creditor first name, and attorney name. The lines 822 depicted in FIG. 16 includes the following input search criteria: index number, type of lien, date filed range, against last name/company, against first name, claimant last name/company, claimant first name, and attorney name. The lis pendens 824 depicted in FIG. 17 includes the following input search criteria: index number, sequence number, date filed range; tax map ID range, plaintiff, plaintiff first name, defendant last name, defendant first name. The mortgages 826 depicted in FIG. 18 includes the following input search criteria: liber and page, tax map ID, mortgagor's last name, mortgagor's first name, mortgagor's corporate name, mortgagee's last name, mortgagee's first name, and mortgagee's corporate name. Finally, the UCCs 830 depicted in FIG. 19 includes the following input search criteria: UCC number, UCC type, date filed range, tax map ID, UCC debtor last name and UCC debtor first name.

Returning back to FIG. 3, at step 306, it is determined at the web server 112 whether an integrated search 818 (FIGS. 11, 14) was selected by the subscriber 102-106. If a search type other than integrated search was selected at step 306, the method flowchart continues at step 310, where the web server 112 passes a generated search for the particular search type selected by the subscriber 102-106. Each search is stored in the database SGA memory and is cleared in a first in first out method. The generated search is an SQL statement which is passed to the integrated data repository 114 for execution. The IIS resident on the web server 112 acts as a broker to pass the generated search to the integrated data repository 114. Alternatively, if at step 306 it is determined that the subscriber has selected an integrated search, then at step 308 the web server 112 generates and executes a search for each search type included the integrated search.

Lastly with reference to FIG. 3, after the particularly selected search is executed, whether it is an integrated search type at step 308 or otherwise another selected search type at step 310, the method flowchart 300 continues at step 312, where the web server 112 retrieves from integrated data repository 114 resulting data (one or more records) and the links to the document images available for the resulting data which are maintained by the image server 122. More specifically, for each record in the retrieved resulting data, unique indexing key information is passed to the image server 122. The index key is part of the returned query results executed by the user, and are included in the searchable data tables. If there is matching indexing key maintained at the image server 122, then a link to the document image will be displayed to the subscriber 102-106 for the particular record displayed. At step 314, the integrated data repository 114 automatically saves an indication of the executed search by the particular search criteria in the history data store 118. The resulting data for the search is transmitted by the web server 112 to the subscriber 102-106 for display by search type at step 316. At step 318, it is determined whether the subscriber 102-106 desires to generate a search watch for the previously executed search. If the subscriber chooses to generate a watch, the method continues at step 320, which is described and elucidated herein below with reference to FIG. 4 below. Alternatively, if the subscriber chooses not to generate a watch at step 318, the method flowchart 300 continues at step 322 where it is determined whether the subscriber desires to generate an abstract for the previously executed search. If the subscriber chooses to generate an abstract, the method flowchart continues at step 224, which is described and elucidated with reference to FIG. 5 below. Alternatively, if the subscriber chooses not to generate and abstract, the method flowchart continues at step 324 where it is determined whether the subscriber desires to export the resulting data of the executed search. If export is desired, the method flowchart 300 continues at step 228 in FIG. 6. Alternatively, the method flowchart ends at step 326.

FIG. 4 depicts an exemplary method flowchart 400 to generate a watch for a particularly executed search in accordance with the present invention. The method flowchart begins at step 320 continuing from FIG. 3. At this point, resulting data by search type for a particular search has been transmitted to and displayed to the subscriber 102-106. At step 402, the subscriber saves the search as a watch. This is accomplished by the subscriber transmitting to the web server 112 a request desiring to save the executed search, wherein the web sever 112 communicates this request to the integrated search repository 114 which saves the search to the watch data store 120. More specifically, when the IIS on the web server 112 receives a request to save a search from a client 102-106, it passes the request to the integrated repository 114, which in turn saves the search to the watch data store 120. At step 404, it is determined whether there is a saved search (i.e., a watch) to re-execute by the integrated data repository 114. If it is determined there is no watch to re-execute, the method flowchart 400 ends at step 418. Alternatively, if there is one or more watch, the method flowchart 400 continues at step 406, where the one or more search is re-executed at predetermined time intervals (e.g., hourly, daily, weekly, etc.) by the integrated data repository 114. The integrated data repository 114 is updated at predetermined periodicity against its virtual combined view of the data records of data stores 126-132. Although a variety of methods may be employed to re-execute the one or more searches, it is preferred to execute one or more SQL batch jobs on the integrated data repository 114 at the aforementioned predetermined periodicity to execute the one or more watches of each user. At step 408, the integrated data repository 114 retrieves resulting data and links to the document images available for the resulting data. At step 410, the resulting data of the re-executed search is compared to the resulting data of the previously saved search. It will be appreciated that a variety of comparisons may be made between the re-executed search and the previously saved search as may be required for a particular purpose. However, it is preferable compare the number of records returned by the different searches.

Further with reference to FIG. 4 in combination with FIG. 9, the current record count of the resulting data of the re-executed search is compared by the integrated data repository 114 to the last record count of the resulting data of the previously executed search. At step 412, it is determined whether the resulting data has changed between the re-executed search and the previously executed search. If it is determined that no change has occurred, the method flowchart 400 loops back to and continues at step 404, with the search being re-executed at the next interval at step 406. The searches and re-searches are preferably accomplished by the integrated data repository 114 by executing one or more database SQL jobs at predetermined periodicity. Alternatively, if a change has occurred at step 412, the method flowchart 400 continues at step 414 where the saved resulting data of previously executed search is updated with the resulting data of re-executed search at the watch data store 120 by the integrated data repository 114. It will be appreciated that a variety of updates may be chosen as may be required for a particular purpose. However, it is preferable to update the current record count 906 as depicted in FIG. 9. Next, at step 416 the subscriber 102-106 is notified of the change in resulting data. This is accomplished by the integrated data repository 114 transmitting an indication to the web server 112 to notify the subscriber 102-106 of the change in the watched search. Thereafter, the integrated data repository 114 via the web server 112 notifies the subscriber associated with the search of the change that occurred in the resulting data of the search being watched. Notification may be accomplished in a variety if ways; however, it is preferably accomplished by sending email notification to the user's email account or hand held device provided by the user at registration. After notification the subscriber may access the land records system 100 to determine what particularly has changed. Thereafter, the method flowchart 400 continues at step 404 for another iteration, which determines whether there are saved watches and re-executes these watches at predetermined time intervals. Alternatively, the method flowchart ends at step 418. It is to be noted that the watch process described with reference to FIG. 4 is performed only if there are existing watches and at predetermined time intervals described hereinabove.

FIG. 5 depicts an exemplary method flowchart 500 to generate an abstract for a particularly executed search in accordance with the present invention. It will be appreciated with reference to the following description that an abstract is a report that abstracts selected or all records in accordance with search type. The method flowchart begins at step 224 continuing from either of FIG. 2 or FIG. 3 described hereinabove. At this point, resulting data by search type for a particular search has been transmitted and displayed to the subscriber 102-106. Reference is made by way of example to an exemplary search in FIG. 10, where a search has been performed for only mortgages and displayed to the subscriber 102-106. Now with reference to FIGS. 5 and 10, at step 502, the subscriber 102-106 selects one or more records from the resulting data displayed by search type. The selection is accomplished by checking one or more, or all, of the desired records in column 1002 of FIG. 10 and clicking abstract 1022.

Further with reference to FIG. 5, at step 504, it is determined which records, whether all or only selected records, are to be abstracted. If it is determined that the subscriber desires to abstract selected records, the method flowchart 500 continues at step 510, where the web server 114 generates an abstract for the selected records of the resulting data by search type and transmits the abstract to the subscriber 102-106 for display. Then, at step 512, it is determined whether the subscriber would like to display only the selected records or the selected records and a trail of non-selected records. If it is determined that a display of only selected records is desired, then at step 514 the generated abstract is displayed for selected records by search type. Alternatively, if it is determined that a display of selected records and a trail of non-selected records is desired, then at step 516 the generated abstract is displayed listing the selected records and trial of non-selected records by search type. Now returning back to step 504, if it determined that the subscriber desires to abstract all records, the method flowchart 500 continues at step 506, where the web server 114 generates an abstract for all records of the resulting data by search type and transmits the abstract to the subscriber 102-106 for display. Then, at step 508 the generated abstract is displayed listing all records by search type. Thereafter, the method flowchart continues at step 518, where it is determined whether the user desires to print the abstract. If it is determined that printing is desired, then at step 520 the abstract is delivered to subscriber's printing device at which it is printed. If no printing is desired, the method flowchart 500 continues at step 522, where the method flowchart 500 ends.

FIG. 6 depicts an exemplary method flowchart 600 for exporting a particularly executed search in accordance with the present invention. The method begins at step 228 continuing from either FIG. 2 or 3 described hereinabove. At step 602, the subscriber 102-106 selects one or more records from the resulting data displayed by search type. For example with reference to FIG. 10, the selection is accomplished by checking one or more, or all, of the desired records in column 1002 of FIG. 10 and clicking abstract 1024. At step 604, it is determined which records, whether all or only selected records, are to be exported. If it is determined at step 604 that the subscriber desires to export only selected records, the method flowchart 500 continues at step 608, where the web server 114 converts selected records of resulting data by search type into a predetermined format (e.g., Excel or another desired format). Alternatively, if it is determined at step 604 that the subscriber desires to export all records, the method flowchart 500 continues at step 6068, where the web server 114 converts all records of resulting data by search type into a predetermined format (e.g., Excel or another desired format). Thereafter, the method flowchart continues at step 610, where the converted records are transmitted to the subscriber 102-106. The transmitted records are displayed in the predetermined format at step 612, and they can be saved or printed in the converted format by the subscriber 102-106 on the subscriber's computer or printer, respectively. The method flowchart 600 continues at step 614, where the method flowchart 500 ends.

While the present invention has been particularly shown and described with regard to preferred embodiments thereof, it will be understood by those skilled in the art that the foregoing and other changes in form and detail may be made therein without departing from the spirit and scope of the present invention

Having thus described our invention, what we claim as new, and desire to secure by Letters Patent is:

1. A method for performing a search for property records stored and maintained across a plurality of data stores, each data store storing and maintaining property records by a type of records, the method comprising:
(a) generating a virtual view of the data records maintained by the plurality of data stores;
(b) selecting a search type for the type of records to search;
(c) entering search criteria in accordance with the selected search type;
(d) executing at least one search of the virtual view using the entered search criteria and the selected search type; and
(e) retrieving resulting data and displaying one or more records of the resulting data by the type of records.

2. The method for performing a search for property records in accordance with claim 1, wherein the search type is one selected from the group consisting of: civil court minutes, deeds, historical maps, judgments, liens, lis pendens, mortgages, town assessors and UCCs, filed maps, and integrated including one or more of previously recited search types.

3. The method for performing a search for property records in accordance with claim 2, the entered search criteria for civil count minutes includes one or more of: index number, plaintiff, defendant, and record document type.a

4. The method for performing a search for property records in accordance with claim 2, the entered search criteria for deeds includes one or more of: liber and page, tax map ID, grantor's last name, grantor's first name, grantor's corporate name, grantee's last name, grantee's first name, and grantee's corporate name.

5. The method for performing a search for property records in accordance with claim 2, the entered search criteria for integrated search type includes one or more of: last name, first name, corporate name, selection of one or more search types, date range, tax map ID range, index number, liber and page, document date and day sequence number.

6. The method for performing a search for property records in accordance with claim 2, the entered search criteria for liens includes one or more of: index number, type of lien, date filed range, against last name/company, against first name, claimant last name/company, claimant first name, and attorney name.

7. The method for performing a search for property records in accordance with claim 2, the entered search criteria for judgments includes one or more of: index number, sequence number, date filed range; debtor last name/company, debtor first name, creditor last name/company, creditor first name, and attorney name.

8. The method for performing a search for property records in accordance with claim 2, the entered search criteria for lis pendens includes one or more of: index number, sequence number, date filed range; tax map ID range, plaintiff, plaintiff first name, defendant last name, defendant first name.

9. The method for performing a search for property records in accordance with claim 2, the entered search criteria for mortgages includes one or more of: liber and page, tax map ID, mortgagor's last name, mortgagor's first name, mortgagor's corporate name, mortgagee's last name, mortgagee's first name, and mortgagee's corporate name.

10. The method for performing a search for property records in accordance with claim 2, the entered search criteria for UCCs includes one or more of: UCC number, UCC type, date filed range, tax map ID, UCC debtor last name and UCC debtor first name.

11. The method for performing a search for property records in accordance with claim 1, further comprising the steps of:
watching the executed search to determine whether the resulting data for the search have changed; and
notifying a subscriber if the resulting data for the search have changed since the search was previously executed.

12. The method for performing a search for property records in accordance with claim 1, further comprising the steps of:
selecting records of the resulting data of the executed search to abstract;
abstracting selected records of the resulting data; and
displaying to a subscriber the abstracted records data grouped by type of records;

13. The method for performing a search for property records in accordance with claim 12, further comprising the steps of:
selecting whether to display records not selected for abstracting; and
displaying a trail on non-selected records to the subscriber if in accordance with the selection.

13. An online electronic system for performing a search of property records over a network, the system comprising:
at least one computing device for generating one or more search requests to perform the search of property records over the network;
a plurality of land data stores, each data store storing and maintaining property records for a type of records;
a virtual land kiosk for:
(i) generating a virtual view of the data records maintained by the plurality of data stores;
(ii) receiving from the computing device a search type for the type of records to search and search criteria in accordance with the search type for each search request;
(iii) executing at least one search of the virtual view using the received search criteria and the selected search type for each search request; and
(iv) transmitting resulting data including one or more records by the type of records to the at least one computing device for display.

14. The online electronic system for performing a search of property records over a network in accordance with claim 13, wherein the virtual land kiosk comprises:
an integrated data repository for: (i) maintaining the virtual view of the data records maintained by the plurality of data stores; and (ii) executing the at least one search of the virtual view using the inputted search criteria and the selected search type for each search request.

15. The online electronic system for performing a search of property records over a network in accordance with claim 14, wherein the virtual land kiosk comprises:
a web server for: (i) receiving the one or more search requests from the at least one computing device; and (ii) transmitting the resulting data to the at least one computing device for display.

16. The online electronic system for performing a search of property records over a network in accordance with claim 15,
wherein the virtual land kiosk further comprises a watch data store for maintaining one or more watches for the at least one executed search;
wherein the integrated data repository is further for determining whether the resulting data for the one or more watches maintained by the watch data store have changed; and
wherein the web server is further for notifying a subscriber if the resulting data for the search have changed since the search was previously executed based on the determination by the integrated data repository.

17. The online electronic system for performing a search of property records over a network in accordance with claim 15,
wherein the virtual land kiosk further comprises a history data store for maintaining history of searches executed for each particular property record.

18. The online electronic system for performing a search of property records over a network in accordance with claim 13,
wherein the virtual land kiosk further comprises an abstract data store for maintaining one or more abstracts;
wherein the integrated data repository is further for generating the an abstract comprising selected records for each of the at least one executed search for maintenance by the abstract data store; and
wherein the web server is further for transmitting the abstracted records data grouped by type of records to the at least one computing device for display.

19. The online electronic system for performing a search of property records over a network in accordance with claim 18,
wherein the integrated data repository is further for generating a trail on non-selected records in accordance for each of the at least one executed search; and
wherein the web server is further for transmitting the trail of non-selected records grouped by type of records to the at least one computing device for display.

20. A program storage device readable by a machine, tangibly embodying a program of instructions executable on the machine to perform a method for performing a search for property records stored and maintained across a plurality of data stores, each data store storing and maintaining property records by a type of records, the method comprising the steps of:
(a) generating a virtual view of the data records maintained by the plurality of data stores;
(b) selecting a search type for the type of records to search;
(c) entering search criteria in accordance with the selected search type;
(d) executing at least one search of the virtual view using the entered search criteria and the selected search type; and
(e) retrieving resulting data and displaying one or more records of the resulting data by the type of records.

21. The program storage device in accordance with claim 20, wherein the method further comprises the steps of:
watching the executed search to determine whether the resulting data for the search have changed; and
notifying a subscriber if the resulting data for the search have changed since the search was previously executed.

22. The program storage device in accordance with claim 20, wherein the method further comprises the steps of:
selecting records of the resulting data of the executed search to abstract;
abstracting selected records of the resulting data; and
displaying to a subscriber the abstracted records data grouped by type of records;

23. The program storage device in accordance with claim 20, wherein the method further comprises the steps of:
selecting whether to display records not selected for abstracting; and
displaying a trail on non-selected records to the subscriber if in accordance with the selection.
